(19) United States
(12) Patent Application Publication
(10) Pub. No.: US 2025/0013556 A1
(43) Pub. Date: Jan. 9, 2025

(54) APPARATUS AND METHOD FOR EXTRACTING AND ANALYZING RUNTIME SOFTWARE EXECUTION INFORMATION

(71) Applicant: ELECTRONICS AND TELECOMMUNICATIONS RESEARCH INSTITUTE, Daejeon (KR)

(72) Inventors: Inhyeok JANG, Daejeon (KR); Suh-Ho LEE, Daejeon (KR); Sung-Jin KIM, Daejeon (KR); Ju-Hyung SON, Daejeon (KR); Byungjoon KIM, Daejeon (KR)

(21) Appl. No.: 18/405,059

(22) Filed: Jan. 5, 2024

(30) Foreign Application Priority Data
Jul. 7, 2023 (KR) 10-2023-0088578

(51) Int. Cl. G06F 11/36

(52) U.S. Cl. CPC G06F 11/3612; G06F 11/3636

(57) ABSTRACT

Disclosed herein is an apparatus and method for extracting and analyzing runtime software execution information. The apparatus may include a collection unit for collecting execution-related data by tracing functions of an operating system on which software is executed or access to data and an analysis unit for generating required information by analyzing the collected execution-related data.

### CROSS REFERENCE TO RELATED APPLICATION

This application claims the benefit of Korean Patent Application No. 10-2023-0088578, filed Jul. 7, 2023, which is hereby incorporated by reference in its entirety into this application.

### BACKGROUND OF THE INVENTION

### 1. Technical Field

The disclosed embodiment relates generally to technology for extracting and analyzing information related to execution of software, such as information about software components that are used when the software is running in a computer system, at runtime, and more particularly to technology for collecting data related to execution of software depending on the operation of the software and analyzing the data.

### 2. Description of Related Art

As a computing environment is transitioned to a cloud environment, cloud-native technologies that maximize service efficiency by implementing microservices using containers and quickly reflecting software requirements through DevOps are actively introduced.

Modern software development methods enable complex software to be quickly and efficiently implemented using already developed software components and used for services. In modern software, software components and container image repositories, which enable development and operation environments to be easily established by sharing and downloading software packages and software development/execution environments, have become essential elements in order to make use of a lot of existing software.

Such modern software and cloud technologies quickly and efficiently provide highly complex functionalities, thereby enabling large-scale services, which used to be impossible in the past.

Meanwhile, as the transition of computing environments to cloud environments and the deployment and execution of software through containers become commonplace, a method for analyzing the operation of software that is executed by being decomposed into a large number of containers in a large-scale execution environment and identifying and responding to performance and security issues is required.

In particular, as security vulnerabilities in software used in numerous computer systems all over the world are disclosed and as large-scale cybersecurity breaches using a software supply chain continue to occur, the seriousness of the current state in which there is lack of information about software components operating in computing instances is perceived.

Also, when an incident requiring investigation, such as a cybersecurity breach, occurs, forensic data is required, but it is very difficult to acquire such forensic data from a cloud system implemented based on virtualization technology after the incident. In particular, it is challenging to trace operation of containers using the existing technology after the incident, because the containers may already disappear due to the temporary nature of the containers and the fluidity of an execution environment, such as a network. Therefore, it is necessary to proactively acquire, store, and analyze required information at runtime while software is running.

In order to extract required information related to software execution at runtime, log file analysis, debugging tools, system-monitoring tools, memory analysis techniques, and the like may be used. However, it is very difficult to timely extract the required information from software running in a modern large-scale computer system such as a cloud and to analyze the same.

For example, log files can be generated only when software developers keep a log for functionalities for which they think a log is required, so it may be impossible to extract relevant information when software is executed.

Also, because debugging tools are typically designed to be used in a development phase, it is difficult to use the debugging tools in an actual software execution environment.

Also, because system-monitoring tools provide measurements with a focus on system performance analysis, they are suitable for performance and load monitoring, but it is difficult to extract required information from system resources that are used during software operation using such system-monitoring tools.

Memory analysis tools may extract desired information by analyzing memory used by software, but have limitations in real-time analysis of a large-scale system.

### SUMMARY OF THE INVENTION

An object of the disclosed embodiment is to identify resources related to software execution, thereby dynamically extracting desired information from a related source and analyzing the same.

Another object of the disclosed embodiment is to enable real-time monitoring of performance and security, runtime software component analysis, acquisition of forensic information at runtime, and the like in a cloud environment, or the like.

An apparatus for extracting and analyzing runtime software execution information according to an embodiment may include a collection unit for collecting execution-related data by tracing a function of an operating system on which software is executed or access to data and an analysis unit for generating required information by analyzing the collected execution-related data.

Here, when an instrumentation event is triggered by instrumenting a system call or a kernel function in a kernel, the collection unit may collect basic information related to execution of a process and software-execution-related data including a file, memory, a system call, and a function related to software execution at the time of execution of software and transfer the collected basic information and software-execution-related data to the analysis unit.

Here, the basic information may include at least one of an event occurrence time, a process ID, a thread ID, a process name, a process execution path, parent process information, namespace information, or container information, or a combination thereof.

Here, the analysis unit may receive the basic information and the software-execution-related data from the collection unit and perform analysis thereon using at least one of decoding, parsing, or filtering, or a combination thereof depending on the format of the data, thereby generating desired information.

Here, in order to identify a software component included in the software being executed, the analysis unit may use a software artifact referred to by the software.

Here, the software artifact may be in one of forms including source code, an object file, a Java class file, a Java Archive (JAR) file, an executable file, and a container.

Here, the software artifact may include at least one software component or package and at least one piece of artifact metadata including information about the artifact.

Here, the analysis unit may acquire component information from the artifact or extract and analyze metadata including component information.

A method for extracting and analyzing runtime software execution information according to an embodiment may include collecting execution-related data by tracing a function of an operating system on which software is executed or access to data and generating required information by analyzing the collected execution-related data.

Here, collecting the execution-related data may comprise, when an instrumentation event is triggered by instrumenting a system call or a kernel function in a kernel, collecting basic information related to execution of a process and software-execution-related data including a file, memory, a system call, and a function related to software execution at the time of execution of software.

Here, the basic information may include at least one of an event occurrence time, a process ID, a thread ID, a process name, a process execution path, parent process information, namespace information, or container information, or a combination thereof.

Here, generating the required information may comprise generating desired information by performing analysis using at least one of decoding, parsing, or filtering, or a combination thereof depending on the formats of the collected basic information and software-execution-related data.

Here, generating the required information may comprise using a software artifact referred to by the software being executed in order to identify a software component included in the software.

Here, the software artifact may be in one of forms including source code, an object file, a Java class file, a JAR file, an executable file, and a container.

Here, the software artifact may include at least one software component or package and at least one piece of artifact metadata including information about the artifact.

Here, generating the required information may comprise acquiring component information from the artifact or extracting and analyzing metadata including component information.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a configuration diagram of an apparatus for extracting and analyzing runtime software execution information according to an embodiment;

FIG. 2 is a flowchart for explaining a method for extracting and analyzing runtime software execution information according to an embodiment;

FIG. 3 is an exemplary view of a general software artifact;

FIG. 4 is an exemplary view of the configuration of a Java software artifact;

FIG. 5 is a flowchart for explaining a process for acquiring information about software components in a Java ARchive (JAR) that are executed when the JAR is executed according to an embodiment;

FIG. 6 is an exemplary view for explaining a process of identifying JAR runtime software in an apparatus for extracting and analyzing runtime software execution information according to an embodiment;

FIG. 7 is an exemplary view of a detailed implementation diagram of a collection unit of an apparatus for analyzing software execution information according to an embodiment; and

FIG. 8 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

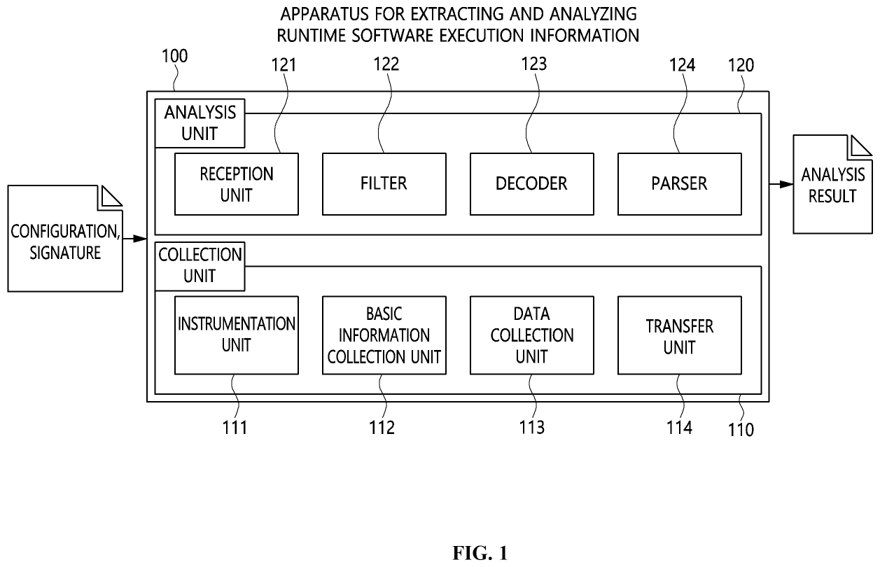

FIG. 1 is a configuration diagram of an apparatus for extracting and analyzing runtime software execution information according to an embodiment.

Referring to FIG. 1, the apparatus for extracting and analyzing runtime software execution information according to an embodiment may include a collection unit 110 for collecting data related to execution of software and an analysis unit 120 for generating required information by analyzing the collected execution-related data.

According to an embodiment, the collection unit 110 may be implemented in a kernel, and the analysis unit 120 may be implemented in user space.

The collection unit 110 traces operating system functions used by software or data access in order to extract the data related to execution of the software.

For example, a file accessed during execution of the software, a method of reading from and writing to the file, and the content of the file may be detected by tracing a system call or kernel function that is invoked when the file is accessed.

Specifically, file information related to the operation of the software is acquired using the path and name of the accessed file, the offset, size, and content of the read or written data, and the like, whereby only the desired data may be extracted.

The extracted data is transferred to the analysis unit 120 such that additional analysis is performed thereon.

Specifically, the collection unit 110 may include an instrumentation unit 111, a basic information collection unit 112, a data collection unit 113, and a transfer unit 114.

The instrumentation unit 111 traces the operation of software by instrumenting a system call or a kernel function in the kernel.

The basic information collection unit 112 collects basic information related to execution of a process, including an event occurrence time, a process ID, a thread ID, a process name, a process execution path, parent process information, namespace information, container information, and the like.

The data collection unit 113 collects necessary information from a file, memory, a system call, a function, and the like related to execution of software when the software is executed.

The transfer unit 114 transfers the collected basic information and data related to execution of the software to the analysis unit 120.

The analysis unit 120 generates desired information by analyzing the software-execution-related data received from the collection unit 110.

Specifically, the analysis unit 120 may include a reception unit 121, a filter 122, a decoder 123, and a parser 124.

The reception unit 121 receives the software-execution-related data collected by the collection unit 110.

Here, the collected data, which is extracted depending on the operation of the software, may be acquired from various sources, such as a file, memory, a system call and the arguments thereof, a kernel function and the arguments thereof, device operations, and the like. Accordingly, the analysis unit 120 may perform analysis to suit the purpose of these various forms of data.

For example, when data is collected from a file related to execution of software, the data may be data that is compressed or encoded using a specific method. In this case, the analysis unit 120 decodes the encoded data using the decoder 123, thereby analyzing the desired data.

Also, the collection unit 110 may collect data that has been already parsed into desired data units depending on the operation of the software. Otherwise, the analysis unit 120 may perform analysis depending on the data format by parsing the collected data using the parser 124, or the like.

Also, the analysis unit 120 may generate additional information by comparing the data received from the collection unit 110 with a given signature according to the purpose of the use of the data, or may perform a filtering process using the filter 122.

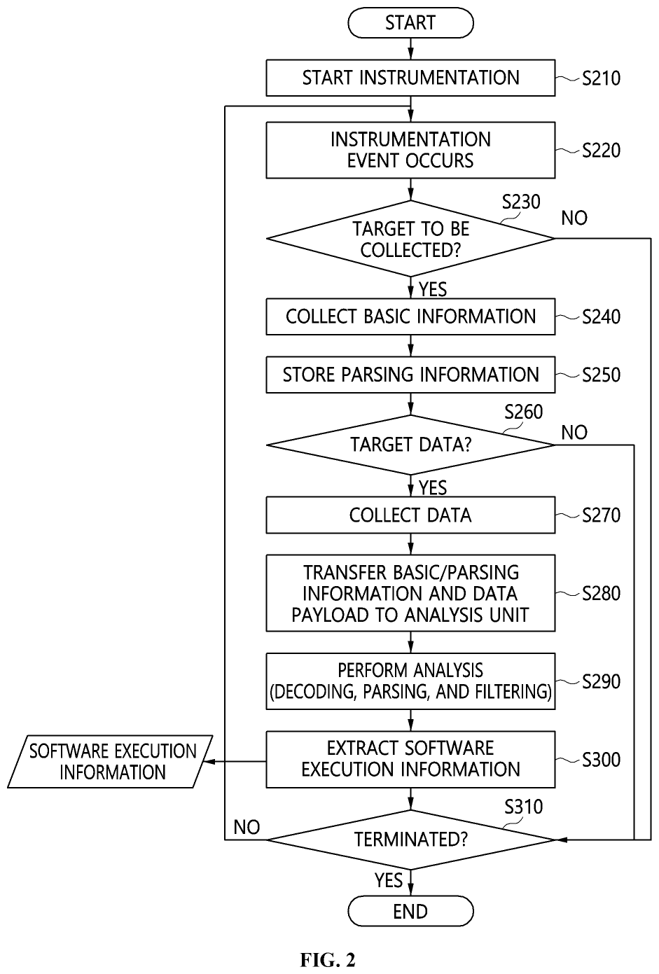

FIG. 2 is a flowchart for explaining a method for extracting and analyzing runtime software execution information according to an embodiment.

Referring to FIG. 2, the collection unit 110 starts instrumentation at step S210, and when an instrumentation event occurs at step S220, the collection unit 110 determines at step S230 whether data generated by the instrumentation event is a target to be collected.

When it is determined at step S230 that the data generated by the instrumentation event is the target to be collected, the collection unit 110 collects basic information about the instrumentation event and stores the same in a map at step S240.

Here, the basic information may be information about software execution and a process, such as an execution path, a process name, a namespace, and the like.

Subsequently, the collection unit 110 stores parsing information pertaining to the instrumentation event at step S250.

Here, the parsing information may be information about parsing, including the current read offset, header information, a file name, and the like.

Here, the collection unit 110 analyzes the parsing information at step S260, and when the current location from which data is read corresponds to a metadata offset, the collection unit 110 may extract the payload of the metadata and store the same in a buffer for transferring data to the analysis unit 120 at step S270.

Subsequently, the collection unit 110 transfers the basic information about the extracted metadata payload and the parsing information to the analysis unit 120 at step S280.

Then, the analysis unit 120 analyzes the received basic information, parsing information, and metadata payload at step S290. For example, the analysis unit 120 may decode the payload based on the content of the parsing information if necessary.

Subsequently, the analysis unit 120 analyzes the decoded payload, thereby extracting software component information, such as the name and version of a software component, and the like, at step S300.

Steps S220 to S300 may be repeatedly performed until execution of the software is terminated at step S310.

With regard to the operation at step S300, an example in which a software component is identified when software is executed will be described in detail.

In order to identify a software component included in software being executed, software artifacts referred to by the software may be used in an embodiment.

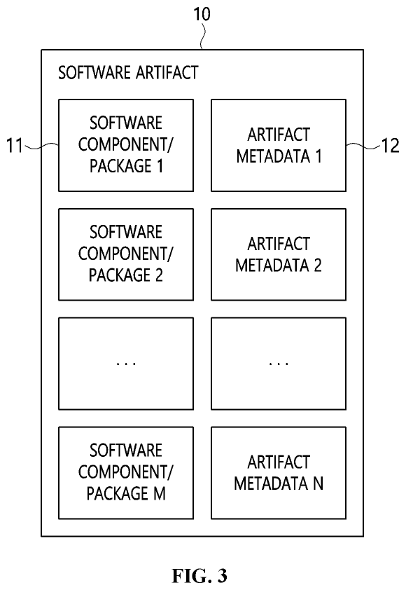

FIG. 3 is an exemplary view of a general software artifact.

Referring to FIG. 3, the software artifact 10 may include at least one software component or package 11 or at least one piece of artifact metadata 12 including information about the corresponding artifact.

The software artifact may be in any of various forms including source code, an object file, a Java class file, a Java Archive (JAR) file, an executable file, a container, and the like.

In an embodiment, the artifact from which software component information can be efficiently extracted during execution of software may be used.

For example, a Java ARchive (JAR) in which components for executing Java software are bundled into a package may include a metadata file, containing specifications of the software package, in the package.

In another example, there may be an artifact configured with a single piece of metadata (e.g., a metadata file or ‘requirement.txt’ of Python) without a software package. In the case of Python, a file containing package information is present in a package installation path, and a file from which additional package information can be acquired is present depending on a package manager. Software component information may be acquired from package managers of various languages, such as C/C++, .Net, Go, Java, Node.js, PHP, Python, Ruby, Rust, and the like.

In an embodiment, component information may be directly read from text, YAML, JSON, or the like when the artifact itself includes component information, or it may be necessary to extract metadata containing component information from the artifact and analyze the same depending on the software artifact that is referred to.

Hereinbelow, a process of identifying software components at the time of executing software according to an embodiment will be described in more detail through an example in which software components included in Java software, which are executed when the Java software is executed, are identified at runtime.

A Java Archive (JAR) may include ‘MANIFEST.MF’, which is metadata on the JAR file. Here, ‘MANIFEST.MF’ includes package-related information, information about main-class for execution, and the like, and is located in the predefined directory ‘META-INF’ (′META-INF/MANIFEST.MF′).

The analysis unit 120 reads package information from the ‘MANIFEST’ file when it starts extraction of component information.

Here, when the JAR file includes no package information, other information may be used. In some JAR packages, ‘pom.xml’ and ‘pom.properties’, which are metadata of Maven, may be extracted and analyzed. This metadata may be extracted in the same manner as extraction from ‘MANIFEST.MF’.

In many cases, software component information may be directly acquired from artifacts, but when it is included in a package such as a JAR, the process of extracting metadata from a corresponding file is required.

Therefore, a method for extracting such metadata at runtime will be described below. Also, because many vulnerabilities having a broad impact, such as Log4Shell and the like, are Java components, a process of extracting software component information from a JAR will be described.

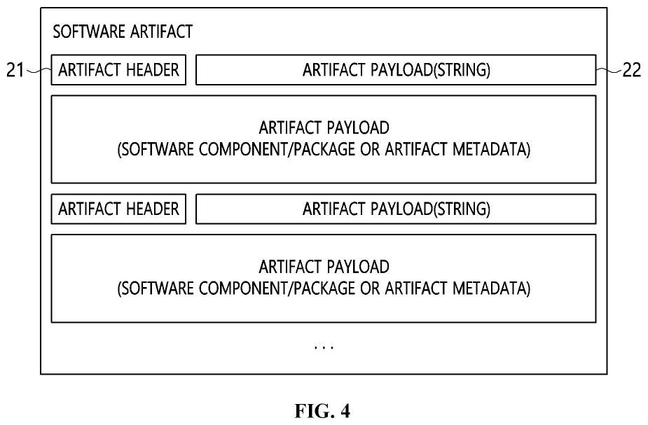

FIG. 4 is an exemplary view of the configuration of a Java software artifact.

Referring to FIG. 4, a header 21 and various payloads 22 are included in a JAR file.

After desired data is extracted by identifying respective components included in the JAR file, decompression has to be completed before the content of a payload including metadata is acquired. Then, the payload is analyzed, whereby the software component information may be acquired.

The JAR file is compressed in a ZIP format, and it is required to analyze the ZIP file format. It seems nonsense to analyze a ZIP file in the kernel, but information may be acquired without directly reading from the ZIP file by observing an analysis process using a kernel technique such as extended Berkeley Packet Filter (eBPF). eBPF does not directly read or parse data, but information that is the same as that used by an application may be acquired by analyzing the data that a Java process reads for parsing.

In order to implement a process of extracting artifact metadata in the kernel, it is necessary to understand a ZIP file format.

The ZIP file format includes three kinds of data, which are an End of Central Directory Record (ECDR), a Central Directory Record (CDR), and a Local File Header (LFH).

A local header is present for each file entry, and a central directory is at the back of the ZIP file. The ECDR is located in the end of the ZIP file, and includes the start location and size of the central directory. Accordingly, the central directory can be read after the ECDR is read.

The ECDR starts with a four-byte signature and includes information such as the number of entries in the ZIP file, the offset of the central directory, the size of the central directory, and the like.

After the ECDR is read, the CDR starts to be read. The CDR includes a central directory header, a file name, and the like for each file entry. The start location of a local file header with which each file entry starts may be acquired from the central directory header.

The header of the CDR also starts with a four-byte signature and contains detailed information about each file entry, including a file name.

The local file header (LFH) is a header coming before actual file data, and includes a file size, a file data size, compression information, and the like.

After the local file header (LFH), the actual file data is located. The local file header (LFH) starts with a four-byte signature and contains a smaller amount of information than the central directory header.

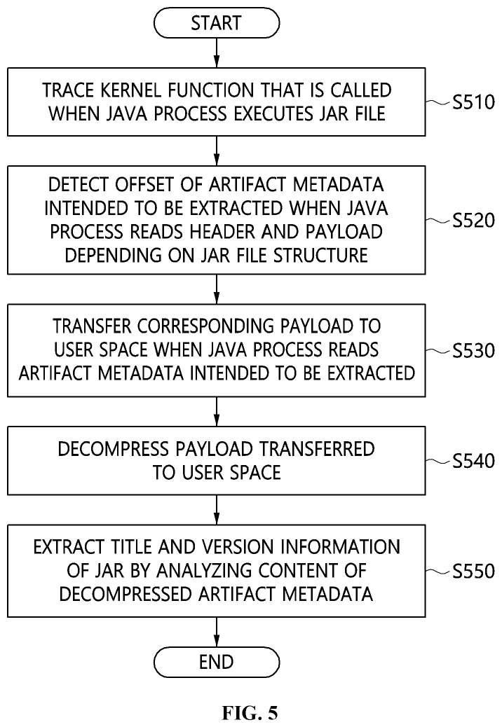

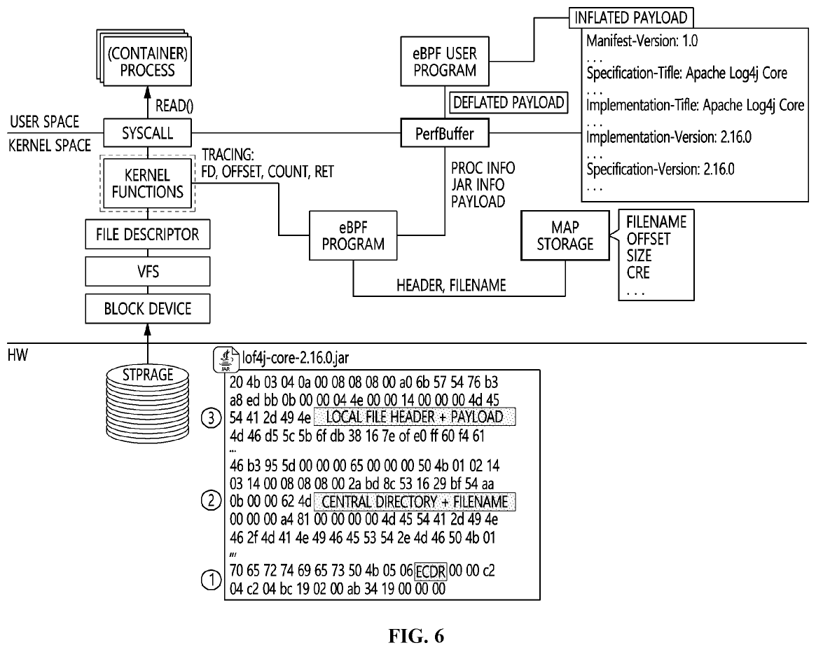

FIG. 5 is a flowchart for explaining a process for acquiring information about software components included in a JAR that are executed when the JAR is executed according to an embodiment, and FIG. 6 is an exemplary view for explaining a process of identifying JAR runtime software in an apparatus for extracting and analyzing runtime software execution information according to an embodiment.

Referring to FIG. 5, a kernel function that is invoked when a JAR file is executed by a Java process is traced at step S510.

The Java process reads data from the JAR file depending on the file structure in order to execute the JAR at step S520. Here, the data read by the Java process is observed using eBPF, and an offset at which the payload of desired metadata is located is detected.

Subsequently, when the Java process reads the data at the corresponding offset, the corresponding payload is extracted and transferred to a program in user space at step S530.

After parsing data is acquired by tracing reading of an ECDR, a CDR including a file path in the JAR file, an LFH, and the payload, information for analysis is stored in an internal map, and, using a perf buffer or a ring buffer, the information is transferred to the program in the user space.

Here, because the transferred payload is compressed with Deflate, it has to be inflated. Therefore, the program in the user space inflates (decompresses) the received payload at step S540 and analyzes the content of the acquired metadata, thereby extracting title and version information, which is information of the JAR file, at step S550. Here, the payload of the detected MANIFEST.MF in the compressed state is transferred. The program in the user space decompresses the compressed MANIFEST.MF and analyzes package information included in the JAR.

When a program for handling the above-described process is configured based on the JAR file structure, the program may be split into a main part for directly tracing ksys_read ( ) and subprograms for handling respective headers, file names, and payloads. Here, the subprograms are written using eBPF tail calls. Because an eBPF program has limits on the stack size (512 bytes) and the number of instructions (4096), it is necessary to split the program in order to handle a complex task. A tail call is one of methods provided by eBPF, and it does not return to the location from which it was called, unlike general functions.

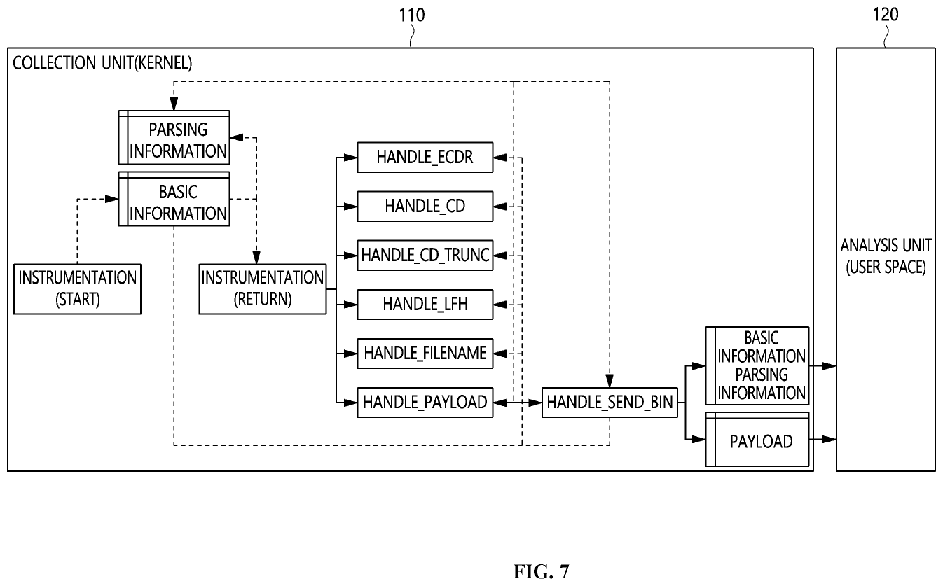

FIG. 7 is an exemplary view of a detailed implementation diagram of a collection unit of an apparatus for analyzing software execution information according to an embodiment. Here, an example of a Java program is described.

Referring to FIG. 7, basic information about a process and execution of software is acquired using kprobe at the point at which instrumentation starts, and is then stored in a map. When execution returns from the instrumentation point (when a function returns), the return value is acquired using kretprobe and is then stored so as to be used for parsing.

Here, the return value is handled by matching the same to the basic information, which was acquired when instrumentation started. Here, the acquired return value and the parsing information are analyzed along with an offset location, a header signature, and the like, whereby the eBPF program to be called is decided on and a suitable eBPF tail call is invoked.

When an End of Central Directory Record (ECDR) is handled, the header thereof is stored in the map, whereby the total number of records, the start offset of a Central Directory Record (CDR), the size of the CDR, and the like are acquired. When a Central Directory (CD) is handled, the header thereof is stored, and a file path is read.

Here, when the size of the CDR is greater than the size of a buffer from which an application reads, the header of the CD or the file path may be truncated. In this case, the truncation is identified and information thereabout is stored in parsing information. When the part that was cut off by the truncation at the time of handling the CD is found during next instrumentation, the truncated CDR is restored by concatenating the found part by invoking a tail call for CD restoration, and analysis is continuously performed by invoking a tail call for CD handling. When a Local File Header (LFH) is handled, a compressed payload size and the like are acquired by storing the LFH, and a file name coming after the size is read.

Here, a file name may not be present in the LFH, and in this case, the information in the CDR that has been read before the LFH may be checked and used. When reading of the offset corresponding to the file name is detected at the time of instrumentation, the file name may be stored by calling an eBPF program for handling the file name. When a payload corresponding to metadata is read depending on the parsing result, an eBPF program for handling the payload is called.

This program extracts the payload based on the parsed offset and payload size information and prepares a buffer to which the basic information, the parsing information, and the payload are transferred when necessary. Then, the data is transferred by calling an eBPF program for data transfer.

Here, the data is transferred in units of chunks depending on the size of the data, whereby a large amount of data may be transferred.

In FIG. 7, the main parts that are processed when instrumentation is performed are as follows.

Depending on a four-byte signature, a tail call for handling the same is invoked. When the signature of an ECDR is found, a Handle_ECDR tail call is invoked, whereby key information is acquired from the ECDR and stored in a map for storing basic information.

When the signature of a CDR is found, a Handle_CD tail call program for handling a central directory repeatedly reads the CDR, thereby reading all entries.

When the size of the central directory is large, an application may read the same in multiple parts, and the truncated part is restored by invoking a Handle_CD_Trunc tail call program for restoring the truncated part.

When the CDR is handled, Handle_Filename and Handle_Payload tail call programs for transferring a file name and a payload to a user program are invoked depending on the conditions.

Here, offset information stored in a parsing information map, which is internally used for JAR parsing, is used.

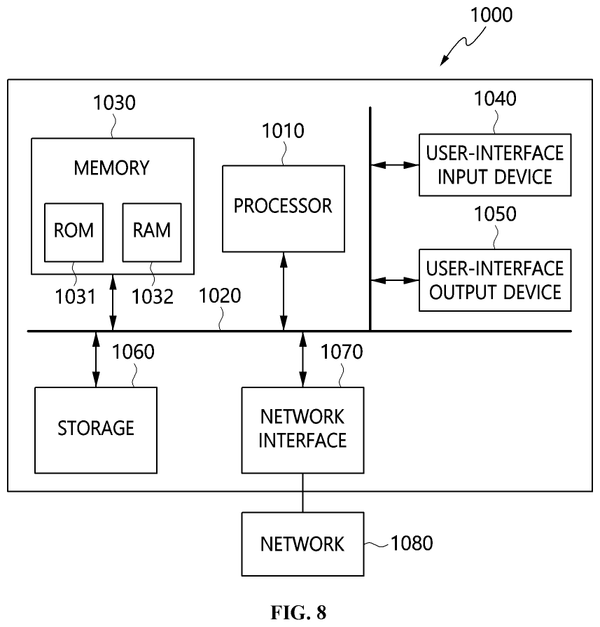

FIG. 8 is a view illustrating a computer system configuration according to an embodiment.

The apparatus according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, desired information may be extracted by dynamically collecting and analyzing data related to execution of software at runtime. Because data is collected depending on the operation of software, data may be collected from only the data actually used by the software, among a lot of potential data to be examined. Also, only desired data may be collected from the data used by the software.

According to the disclosed embodiment, when the collected software execution information is used, visibility is obtained in a cloud system, and necessary information is extracted by observing data actually used by software. Accordingly, countermeasures to performance and security issues can be prioritized, whereby the efficiency of the countermeasures may be improved.

According to the disclosed embodiment, software components and versions that are actually used by software being executed in a computer system are identified, or information is extracted, stored, and used for future analysis by analyzing data used by the software in real time depending on the operation of the software in a large-scale virtualization system, such as a cloud or the like. Accordingly, the information may be used in order to improve the security of modern computer systems, such as container and cloud-native environments.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for extracting and analyzing runtime software execution information, comprising:
a collection unit for collecting execution-related data by tracing a function of an operating system on which software is executed or access to data; and
an analysis unit for generating required information by analyzing the collected execution-related data.

2. The apparatus of claim 1, wherein, when an instrumentation event is triggered by instrumenting a system call or a kernel function in a kernel, the collection unit collects basic information related to execution of a process and software-execution-related data including a file, memory, a system call, and a function related to software execution at a time of execution of software and transfers the collected basic information and software-execution-related data to the analysis unit.

3. The apparatus of claim 2, wherein the basic information includes at least one of an event occurrence time, a process ID, a thread ID, a process name, a process execution path, parent process information, namespace information, or container information, or a combination thereof.

4. The apparatus of claim 2, wherein the analysis unit receives basic information and software-execution-related data from the collection unit and performs analysis thereon using at least one of decoding, parsing, or filtering, or a combination thereof depending on a format of the data, thereby generating desired information.

5. The apparatus of claim 4, wherein, in order to identify a software component included in software being executed, the analysis unit uses a software artifact referred to by the software.

6. The apparatus of claim 5, wherein the software artifact is in one of forms including source code, an object file, a Java class file, a Java Archive (JAR) file, an executable file, and a container.

7. The apparatus of claim 5, wherein the software artifact includes at least one software component or package and at least one piece of artifact metadata including information about the artifact.

8. The apparatus of claim 7, wherein the analysis unit acquires component information from the artifact or extracts and analyzes metadata including component information.

9. A method for extracting and analyzing runtime software execution information, comprising:
collecting execution-related data by tracing a function of an operating system on which software is executed or access to data; and
generating required information by analyzing the collected execution-related data.

10. The method of claim 9, wherein collecting the execution-related data comprises, when an instrumentation event is triggered by instrumenting a system call or a kernel function in a kernel, collecting basic information related to execution of a process and software-execution-related data including a file, memory, a system call, and a function related to software execution at a time of execution of software.

11. The method of claim 10, wherein the basic information includes at least one of an event occurrence time, a process ID, a thread ID, a process name, a process execution path, parent process information, namespace information, or container information, or a combination thereof.

12. The method of claim 10, wherein generating the required information comprises generating desired information by performing analysis using at least one of decoding, parsing, or filtering, or a combination thereof depending on formats of collected basic information and software-execution-related data.

13. The method of claim 12, wherein generating the required information comprises using a software artifact referred to by software being executed in order to identify a software component included in the software.

14. The method of claim 13, wherein the software artifact is in one of forms including source code, an object file, a Java class file, a Java Archive (JAR) file, an executable file, and a container.

15. The method of claim 14, wherein the software artifact includes at least one software component or package and at least one piece of artifact metadata including information about the artifact.

16. The method of claim 15, wherein generating the required information comprises acquiring component information from the artifact or extracting and analyzing metadata including component information.
